(19) United States
(12) Patent Application Publication
(10) Pub. No.: US 2026/0332358 A1
(43) Pub. Date: Oct. 22, 2026

(54) METHOD AND APPARATUS FOR CONFIGURING TIMING PARAMETERS IN COMMUNICATION SYSTEM

(71) Applicant: SOLiD, INC., Seongnam-si, Gyeonggi-do (KR)

(72) Inventor: Hoony HONG, Seoul (KR)

(73) Assignee: SOLiD, INC., Seongnam-si, Gyeonggi-do (KR)

(21) Appl. No.: 19/106,869

(22) PCT Filed: Aug. 30, 2023
(86) PCT No.: PCT/KR2023/012931

§ 371 Date: May 28, 2025

(30) Foreign Application Priority Data
Aug. 30, 2022 (KR) 10-2022-0108892
Sep. 19, 2022 (KR) 10-2022-0118086

(51) Int. Cl. H04L 5/00; H04W 72/0446; H04W 72/29; H04W 72/542; H04W 88/08

(52) U.S. Cl. CPC H04L 5/0094; H04W 72/0446; H04W 72/29; H04W 72/542; H04W 88/085

(57) ABSTRACT

According to an embodiment of the disclosure, a method performed by a controller in a communication system includes: receiving SCS capability information from each of a plurality of O-RUs; receiving slotId configuration capability information from each of the plurality of O-RUs; generating slotId configuration information based on the received SCS capability information and slotId configuration capability information; and transmitting the generated slotId configuration information to an O-DU and the plurality of O-RUs.

### CROSS-REFERENCE TO RELATED APPLICATIONS

This application is a National Stage of PCT International Application No. PCT/KR2023/012931, filed Aug. 30, 2023, and claims priorities from Korean Patent Application No. 10-2022-0108892, filed Aug. 30, 2022, and Korean Patent Application No. 10-2022-0118086, filed Sep. 19, 2022, the contents of which are incorporated herein by reference in their entireties.

### BACKGROUND

### 1. Field

The disclosure relates to a method and apparatus for obtaining timing parameters, which are configurations of a control/user plane used when configuring a cell in a communication system.

### 2. Description of the Related Art

As wireless communication systems develop and evolve into 4th generation (4G) communication systems, 5th generation (5G) communication systems, etc., various functions and specifications are required. In order to satisfy these functions and specifications, various methods have been introduced, and one of them is a method of implementing a network infrastructure structure by functionally splitting it. A representative configuration of the functional split method is that a base station can be expressed as a centralized unit (CU), a distributed unit (DU) and a radio unit (RU) according to its function, and interfaces of respective units are defined by organizations such as 3GPP and the O-RAN alliance.

### SUMMARY

Provided are methods for efficiently utilizing communication in a fronthaul or increasing processing capacity in a method of configuring multiple cells or one or more shared cells.

Provided are methods of configuring a shared cell to reduce resource waste and increase communication quality when performing communication in O-RAN.

According to an embodiment of the disclosure, a method performed by a controller in a communication system, the method may include: receiving sub-carrier spacing (SCS) capability information from each of a plurality of O-RUs; receiving slot identifier (slotld) configuration capability information from each of the plurality of O-RUs; generating slotId configuration information based on the received SCS capability information and slotId configuration capability information; and transmitting the generated slotId configuration information to an O-DU and the plurality of O-RUs.

According to an embodiment, the SCS capability information may include information indicating what SCS each of the plurality of O-RUs supports, and the slotId configuration capability information may include information indicating whether each of the plurality of O-RUs may change slotld.

According to an embodiment, the generating slotId configuration information based on the received SCS capability information and slotId configuration capability information may include: identifying whether slotId configuration capability information of at least one O-RU from among the plurality of O-RUs comprises information indicating that slotId can be changed; and, if the slotId configuration capability information of the at least one O-RU comprises information indicating that slotId can be changed, generating the slotId configuration information based on SCS capability information of an O-RU, in which the slotId configuration capability information comprises information indicating that slotId cannot be changed.

According to an embodiment, the generating slotId configuration information based on the received SCS capability information and slotId configuration capability information may include: identifying whether slotId configuration capability information of at least one O-RU from among the plurality of O-RUs comprises information indicating that slotId can be changed; and generating slotId configuration information of the at least one O-RU based on communication quality of the controller.

According to another embodiment of the disclosure, a controller in a communication system, the controller may include: a transceiver; a memory; and at least one processor electrically connected to the transceiver and the memory, wherein the at least one processor is configured to: receive sub-carrier spacing (SCS) capability information from each of a plurality of O-RUs; receive slot identifier (slotld) configuration capability information from each of the plurality of O-RUs; generate slotId configuration information based on the received SCS capability information and slotId configuration capability information; and transmit the generated slotId configuration information to an O-DU and the plurality of O-RUs.

According to an embodiment of the disclosure, by unifying slotId configurations of O-RUs included in a shared cell or multiple cells, configuration of the shared cell may be efficiently performed or processing capacity in a DU may be improved.

Effects according to the inventive concept of the disclosure are not limited to the effects described above, and other effects not described herein may be clearly understood by one of ordinary skill in the art from the following description.

### BRIEF DESCRIPTION OF THE FIGURES

FIG. 1A is a view of a wireless communication system according to various embodiments of the disclosure.

FIG. 1B is a view illustrating an example of a fronthaul structure according to a functional split of a base station, according to various embodiments of the disclosure.

FIG. 2 is a view of an O-RAN network system according to an embodiment of the disclosure.

FIG. 3 is a view of a structure of an O-RAN wireless communication system according to an embodiment of the disclosure.

FIG. 4 is a view of a structure of an Ethernet message according to an embodiment of the disclosure.

FIGS. 5A and 5B are views illustrating an example of a C-plane message according to an embodiment of the disclosure.

FIG. 6 is a view of a structure of an O-RAN base station including a middle node according to an embodiment of the disclosure.

FIG. 7 is a table of a slot ID index according to an embodiment of the disclosure.

FIG. 8 is a view illustrating a method of configuring slot identifier (slotld) configuration according to an embodiment of the disclosure.

FIG. 9A is a view illustrating a method of performing fronthaul communication according to an embodiment of the disclosure.

FIG. 9B is a view illustrating a method of performing communication through slotld configuration according to another embodiment of the disclosure.

FIG. 10A is a view illustrating a first embodiment of applying slotId configuration according to an embodiment of the disclosure.

FIG. 10B is a view illustrating a second embodiment of applying slotId configuration according to an embodiment of the disclosure.

FIG. 10C is a view illustrating a third embodiment of applying slotId configuration according to an embodiment of the disclosure.

FIG. 10D is a view illustrating a fourth embodiment of applying slotId configuration according to an embodiment of the disclosure.

FIG. 11 is a flowchart illustrating a method of configuring slotId according to an embodiment of the disclosure.

FIG. 12 is a view illustrating a method of performing communication with O-RUs constituting multiple cells through slotId configuration, according to an embodiment of the disclosure.

FIG. 13 is a view of a configuration of a controller according to an embodiment of the disclosure.

FIG. 14 is a view of a configuration of a middle node according to an embodiment of the disclosure.

FIG. 15 is a view of a configuration of an O-DU according to an embodiment of the disclosure.

FIG. 16 is a view of a configuration of an O-RU according to an embodiment of the disclosure.

### DETAILED DESCRIPTION OF EXEMPLARY EMBODIMENTS

Hereinafter, embodiments of the disclosure will be described in detail with the accompanying drawings.

In the description of the embodiments of the disclosure, certain detailed explanations of a related function or configuration are omitted when it is deemed that they may unnecessarily obscure the essence of the disclosure. In addition, the terms described below are defined in consideration of the functions in the disclosure, and may vary depending on the intention or custom of a user or an operator. Therefore, the definition needs to be made based on content throughout this specification.

For the same reason, some components may be exaggerated, omitted, or schematically shown in the accompanying drawings. In addition, the size of each component does not entirely reflect its actual size. In each drawing, identical or corresponding components are given the same reference numerals.

Advantages and features of the disclosure, and implementation methods thereof will be clarified through following embodiments described with reference to the accompanying drawings. However, the disclosure is not limited to the embodiments disclosed below, but may be implemented in various different forms. The embodiments are provided only to ensure that the description of the disclosure is complete and to fully inform one of ordinary skill in the art of the scope of the invention to which the embodiments of the disclosure pertain, and the claimed scope of the disclosure is only defined by the scope of the claims.

At this time, it will be understood that each block of processing flowcharts and combinations of the processing flowcharts may be performed by computer program instructions. Because these computer program instructions may be mounted on a processor of a general-purpose computer, special-purpose computer, or other programmable data processing equipment, the instructions performed through the processor of the computer or other programmable data processing device creates a unit to perform functions described in flow chart block(s). These computer program instructions may also be stored in computer-usable or computer-readable memory that can be directed to a computer or other programmable data processing equipment to implement the functions in a particular manner. Accordingly, the instructions stored in the computer-usable or computer-readable memory may also produce manufactured items containing an instruction unit that performs the functions described in the flow chart block(s). Because the computer program instructions can be mounted on a computer or other programmable data processing equipment, instructions that execute a computer or other programmable data processing equipment by performing a series of operations on a computer or other programmable data processing equipment to generate a computer-executable process may also provide operations for executing the functions described in the flow chart block(s).

In addition, each block may represent a module, segment, or portion of code containing one or more executable instructions for executing specified logical function(s). In addition, in some alternative implementations, it should be noted that functions mentioned in the blocks to occur out of order. For example, two blocks shown in succession may be performed substantially simultaneously, or the blocks may sometimes be performed in reverse order depending on their corresponding functions.

The term “unit or part” used in the disclosure refers to software or hardware components such as a field-programmable gate array (FPGA) or an application specific integrated circuit (ASIC), and the “unit or part” may be configured to perform specific roles. However, the “unit or part” is not limited to software or hardware. The “unit or part” may be configured to be stored in an addressable storage medium or to execute one or more processors. Accordingly, the “unit or part” may include, for example, software components, object-oriented software components, components such as class components and task components, processors, formulas, attributes, procedures, subroutines, segments of program codes, drivers, firmware, micro codes, circuits, data, database, data structures, tables, arrays and variables. Functions provided in components and “units or parts” may be combined into a smaller number of components and “units or parts”, or may be further divided into additional components and “units.” Furthermore, components and “units or parts” may be implemented to reproduce one or more central processing units (CPUs) within a device or a secure multimedia card. In addition, in an embodiment, “unit or part” may include one or more processors and/or devices.

In various embodiments, the technologies described in the disclosure and systems and devices for implementation thereof may utilize other radio access technologies such as WiFi or WiMax as well as radio access technologies such as code division multiple access (CDMA), time division multiple access (TDMA), frequency division multiple access (FDMA), orthogonal FDMA (OFDMA), single-carrier FDMA (SC-FDMA), LTE, a global system for mobile communications (GSM), 5G NR, and the like to support communication between networks (or systems).

Various other embodiments and features according to the inventive concept of the disclosure will be further described later below. It should be apparent that the teachings herein may be implemented in a wide variety of forms and any particular structure, function, or both, disclosed herein are merely exemplary, and not limiting. Based on the teachings herein, those of ordinary skill in the art will appreciate that aspects disclosed herein may be implemented independently of any other aspects, and two or more of these aspects may be combined in various ways. For example, a device or a method may be implemented by using any number of aspects set forth herein. Furthermore, the device or the method may be implemented with structures and functions of one or more of the aspects described herein, or may be implemented by using structures and functions of other aspects. For example, the method may be implemented as a part of commands stored on a non-transitory computer-readable recording medium for execution on a system, a device, an apparatus and/or a processor, or a computer. Furthermore, one aspect may include at least one component of the claim.

Hereinafter, a base station is an entity that performs resource allocation for a terminal and may be at least one of a Node B, base station (BS), eNode B (eNB), gNode B (gNB), a radio access unit, a base station control device, or a node on a network. The terminal may include user equipment (UE), a mobile station (MS), a cellular phone, a smartphone, a computer, or a multimedia system capable of performing communication functions. In addition, the embodiment of the disclosure described below may be applied to other communication systems having a similar technical background or channel type as the embodiment of the disclosure. In addition, the embodiment of the disclosure may be applied to other communication systems through some modifications without significantly departing from the scope of the disclosure, at the discretion of one of ordinary skill in the art.

Terms used in the following description, such as terms for identifying an access node, terms referring to network entities or network functions (NFs), terms referring to messages, terms referring to interfaces between network objects, and terms referring to various identification information, are provided as examples for convenience of explanation. Therefore, the disclosure is not limited to the terms described below, and other terms referring to objects having equivalent technical meaning may be used.

For convenience of explanation below, some terms and names defined in 3rd generation partnership project (3GPP) long-term evolution (LTE), Internet engineering task force (IETF) and IEEE 802 Project standards may be used. However, the disclosure is not limited by the above terms and names, and may be equally applied to systems according to other standards.

Hereinafter, various embodiments according to the inventive concept of the disclosure will be described in detail one by one.

An O-RAN distributed unit (O-DU) may be a part of an O-RAN system, which is generally implemented in software. In more detail, the O-DU may be a logical node hosting an RLC/MACI High-PHY layer based on a lower layer functional split. An O-RAN radio unit (O-RU) may be a logical node that performs RF processing and hosts a Low-PHY layer based on a lower layer functional split. The O-RU may transmit and receive radio signals, which is the biggest feature of 3GPP's “TRP” or “RRH”.

User Equipment (UE) is a device, such as a mobile phone, that allows a user to access a network service.

An uplink (UL) refers to a traffic flow through different network components from the UE to a network and from the O-RU to the O-DU. An interface from the UE to the O-RU is wireless, while a UL traffic from the O-RU to the O-DU may take various forms (e.g., Ethernet connection) such as wireless and wired.

A downlink (DL) refers to a traffic flow through network components from the O-DU to the O-RU and from the network to the UE. A fronthaul interface from the O-DU to the O-RU may have various forms (e.g., Ethernet) such as wired or wireless, while an interface from the O-RU to the UE may be a wireless interface.

The O-RAN specification may include four planes: user plane (U-plane), control plane (C-plane), synchronization plane (S-plane), and management plane (M-plane).

The user plane (U-plane) may be a concept that includes IQ sample data transmitted between the O-DU and the O-RU.

The control plane (C-plane) is a concept that specifically refers to scheduling information, beamforming information transfer, and other real-time control between the O-DU and the O-RU, and may be distinguished from a UE's control plane.

The synchronization plane (S-plane) generally includes time and frequency synchronization configuration and information exchange, and may include other network elements in addition to the O-DU and the O-RU.

The M-plane is a concept that represents a non-real-time management operation for the O-RU.

The non-real-time management operation may be executed bidirectionally by O-RU and O-RU controllers, and the O-RU controller may reside in the O-DU or a service management and orchestration system (SMO), or may exist as a separate device.

An M-plane interface is a link between the O-RU controller and the O-RU to exchange non-real-time management information.

The section type is a delimiter of a C-plane message format and consists of different data fieIds depending on the purpose, such as scheduling format, beamforming information configuration format, ACK/NACK instruction response, and LAA information exchange.

Section extension data is optional additional information attached to the end of section data in a C-plane message that mainly flow from the O-DU to the O-RU, and may transmit additional real-time control information to achieve optimization or support objectives that cannot be achieved in a normal configuration format.

A shared cell may represent a method in which a plurality of O-RUs operate as being included in an identical cell with one or a plurality of component carriers.

The O-DU and the O-RU may be classified according to the presence or absence of a plurality of network elements and links (or data flow) as shown in Table 1 below.

TABLE 1
Cell type classification according to the number and configuration of DU and RU

| Cell type | 1 | 2A | 2B | 3 | 4 |
|---|---|---|---|---|---|
| Terms | Cell | Shared Cell | Shared Cell | Shared O-RU | Shared Cell, |
| | | | | | Shared O-RU |
| DU | 1 | 1 | 1 | 2 or more | 2 or more |
| RU | 1 | 2 or more | 2 or more | 1 | 2 or more |
| Uplan--DL | Single link | Copy | Copy | Single link | Hybrid |
| Uplan--UL | Single link | Combine | Multi-link | Single link | Hybrid |

Starting from the premise of an acceptable configuration without additional implementation and major changes to the UE, basically, the UE does not distinguish between shared cells and non-shared cells and recognizes them as existing cells. Therefore, regardless of the cell type, the identity of a cell is maintained as one. When a cell is configured with a plurality of O-RUs, an excellent propagation environment may be provided by minimizing interference between radio signals such as a broadcasting channel such as System information block (SIB) 1 and a control channel such as group common PDCCH provided as a single layer within the cell.

However, in a shared cell, some signals, such as synchronization signal (SS)/physical broadcast channel (PBCH) and channel state information-reference signal (CSI-RS), may be allocated to O-RUs individually or in groups to support position and selective operation. Therefore, individual O-RUs in a shared cell are not intended to always behave the same.

In terms of O-DU, cell type 2A (shared cell) has basically the same operating principle as cell type 1. However, due to the configuration of a plurality of O-RUs, differences occur in expected performance of a cell and requirements for cell configuration. In terms of radio signal quality, there is an increase in noise power proportional to the number of O-RUs in a UL signal. In terms of message handling, like cell type 1, all network entities are processed as a single message, and thus, a function of copying a DL directional message and combining an UL directional message in the middle of a link between the O-DU and the O-RU is required. Here, combining may be a concept that includes expressions such as sum, aggregate, and add. In O-RAN, a fronthaul multiplexer (FHM) or cascade O-RU is defined as a network node responsible for the function.

In an FHM mode, a shared cell may be configured to deploy an FHM function between at least one O-DU and a plurality of O-RUs. The FHM function may perform copy and combine functions, and like a general O-RU, may also support an LLS fronthaul. Here, combine may include expressions such as combine, sum, aggregate, and add. A plurality of O-RUs connected to the FHM may all share one cell, and may be designed to be divided into multiple cells and shared by group.

As an example, a cascade mode may be configured in such a way that there is one O-RU directly connected to the O-DU and other O-RUs are connected in series to the O-RU.

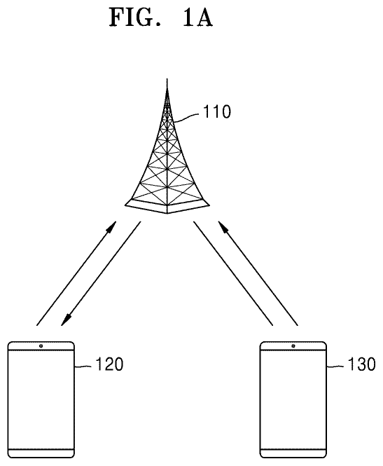

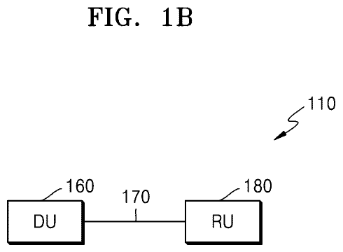

FIG. 1A is a view of a wireless communication system according to various embodiments. FIG. 1A illustrates a base station 110, a first terminal 120, and a second terminal 130 as some of nodes that use a wireless channel in the wireless communication system. FIG. 1A shows only one base station, but other base stations identical or similar to the base station 110 may be further included.

The base station 110 is a network infrastructure that provides radio access to the terminals 120 and 130. The base station 110 has coverage defined as a certain geographic area based on a distance over which signals can be transmitted. The base station 110 may be referred to as “access point (AP)”, “eNodeB (eNB)”, “5th generation node (5G node)”, “next generation nodeB (gNB)”, “wireless point”, “transmission/reception point (TRP)”, or other terms with equivalent technical meaning.

Each of the terminals 120 and 130 is a device used by a user and communicates with the base station 110 through a wireless channel. A link from the base station 110 to the first terminal 120 or the second terminal 130 is called a downlink (DL), and a link from the first terminal 120 or the second terminal 130 to the base station 110 is called an uplink (UL). In addition, the first terminal 120 and the second terminal 130 may communicate with each other through a wireless channel. In some cases, at least one of the first terminal 120 and the second terminal 130 may be operated without user involvement. In other words, at least one of the first terminal 120 and the second terminal 130 is a device that performs machine type communication (MTC) and may not be carried by a user. Each of the first terminal 120 and the second terminal 130 may be referred to as “user equipment (UE)”, “customer premises equipment (CPE)”, “mobile station”, “subscriber station”, “remote terminal”, “wireless terminal”, “electronic device”, “user device”, or other terms having equivalent technical meaning.

Conventionally, in a communication system with a relatively large cell radius of base stations, each base station is installed to include functions of a digital processing unit (or digital unit (DU)) and a radio frequency (RF) processing unit (or radio unit (RU)). However, as higher frequency bands are used in 4th generation (4G) and/or later communication systems and the cell radius of base stations becomes smaller, the number of base stations to cover a specific area increases, and an installation cost burden on an operator to install the increased number of base stations increases. In order to minimize an installation cost of a base station, a structure has been proposed in which a DU and an RU of a base station are split, one or more RUs are connected to one DU through a wired network, and one or more geographically distributed RUs are deployed to cover a specific area.

FIG. 1B is a view illustrating an example of a fronthaul structure according to a functional split of a base station, according to various embodiments. A fronthaul refers to a link between entities between a wireless LAN and the base station, unlike a backhaul between the base station and a core network.

Referring to FIG. 1B, the base station 110 may include a DU 160 and an RU 180. A fronthaul 170 between the DU 160 and the RU 180 may be operated through an Fx interface. For operation of the fronthaul 170, for example, an interface such as enhanced common public radio interface (eCPRI) or radio over Ethernet (ROE) may be used.

As communication technology develops, mobile data traffic increases, and accordingly, a bandwidth requirement for a fronthaul between a DU and an RU increases significantly. In deployment such as a centralized/cloud radio access network (C-RAN), the DU may be implemented to perform functions for packet data convergence protocol (PDCP), radio link control (RLC), media access control (MAC) and physical (PHY), and the RU may be implemented to further perform functions for a PHY layer in addition to an RF function.

The DU 160 may be responsible for an upper layer function of a wireless network. For example, the DU 160 may perform a function of an MAC layer and a portion of the PHY layer. A portion of the PHY layer is performed at a higher level from among the functions of the PHY layer and may include, for example, channel encoding (or channel decoding), scrambling (or descrambling), modulation (or demodulation), or layer mapping (or layer demapping). According to an embodiment, when the DU 160 complies with an O-RAN standard, the DU 160 may be referred to as an O-RAN DU (O-DU). The DU 160 may be represented as a replacement for a first network entity for a base station (e.g., gNB) in embodiments of the disclosure, as needed.

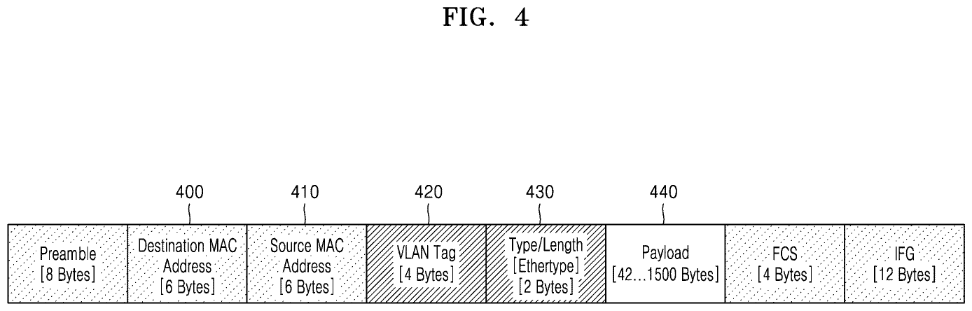

The RU 180 may be responsible for a lower layer function of a wireless network. For example, the RU 180 may perform a portion of the PHY layer and an RF function. Here, a portion of the PHY layer is performed at a relatively lower level than the DU 160 from among the functions of the PHY layer and may include, for example, IFFT conversion (or FFT conversion), CP insertion (CP removal), and digital beamforming. An example of this specific functional split will be described in detail in FIG. 4. The RU 180 may be referred to as “access unit (AU)”, “access point (AP)”, “transmission/reception point (TRP)”, “remote radio head (RRH)”, “radio unit (RU)”, or other terms having equivalent technical meaning. According to an embodiment, when the RU 180 complies with an O-RAN standard, the RU 180 may be referred to as an O-RAN RU (O-RU). The RU 180 may be represented as a replacement for a second network entity (e.g., another FHM) for a base station (e.g., gNB) in embodiments of the disclosure, as needed.

In fronthaul communication between the DU 160 and the RU 180, the RU 180 needs to continuously perform radio transmission and reception specified in 3GPP TS within an error range specified for time and frequency resources (e.g., frequency time error, time alignment error, etc.). To this end, timing and latency of the network infrastructure are managed for each network element, and in particular, DU and RU that handle physical layer signal processing require strict timing control and high accuracy. Because functional split option 7 performs signal processing on a per-symbol basis, IQ data corresponding to each symbol and its processing information need to be transferred between the DU 160 and RU 180 before certain latency. A message arrival point in time may have a relationship as shown in the formula below, which is determined by a transmission point in time and delay time.

Transmission point in time (window)+delay time ≤arrival point in time (window)

Transmit window+transport delay ≤receive window

Usually, there is a DU's fixed timing processing method that secures a sufficient margin for transmission delay based on timing of the RU 180, and a DU's dynamic timing processing method that takes advantage of an additional time secured by varying timing of message transmission and reception for a fronthaul transmission delay. The processing method is determined by the DU 160 because it depends on a message timing management capability of the DU 160. Because it is generally advantageous for the RU 180 to process in the shortest period of time with optimal resources, the RU 180 provides a delay profile according to a certain standard. This standard may be sub-carrier spacing, a bandwidth, a fronthaul (FH) line rate, a buffer depth, a transport flow, etc. Because there are too many parameters between the DU 160 and the RU 180 for delay management of messages, optimization based on consultation between vendors based on use cases is generally expected, rather than a convergence process based on general requirements and relationships. Even if a dynamic timing processing method of the DU 160 is used, this means a dynamic change according to a use case and deployment, and does not mean a dynamic change to a delay that changes dynamically in an already configured cell. It is possible to expand the method to respond semi-statically while accompanied by service deterioration, but there is currently no significant advantage.

O-RAN message timing is managed so that the DU 160 and RU 180 may transmit and receive data smoothly in relation to a transport delay. A UL combining function of a U-plane message for FHM and Cascade O-RU may operate based on ta3-prime-max based on current reference timing tul=0. Ta3-prime-max may be determined by considering Ta4-max and FH transport delay in the DU.

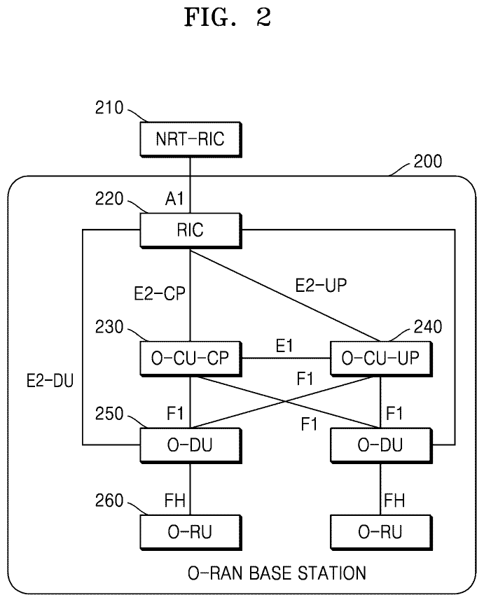

FIG. 2 is a view of an O-RAN network system according to an embodiment. According to FIG. 2, an O-RAN network is a network that logically splits functions of eNB and gNB of existing 4G and 5G systems, and may be defined as a non-real-time (NRT)-RAN intelligent controller (RIC) 210, an RIC 220 within an O-RAN base station 200, O-CU-CP 230, O-CU-UP 240, O-DU 250, O-RU 260, etc. in an O-RAN related standard. The NRT-RIC 210 is a logical node that enables non-real-time control, optimization of RAN elements and resources, model training and updates, etc. The RIC 220 is a logical node that centrally deploys servers in one physical location and enables near-real-time control and optimization of RAN elements and resources based on data collected from the O-DU 250, the O-CU-CP 230, the O-CU-UP 240, etc. through an E2 interface. The O-CU including the O-CU-CP 230 and the O-CU-UP 240 is a logical node that provides functions of radio resource control (RRC), service data adaptation protocol (SDAP), and packet data convergence protocol (PDCP). The O-CU-CP 230 is a logical node that provides functions of a C-plane portion of the RRC and PDCP, and the O-CU-UP 240 is a logical node that provides functions of a U-plane portion of the SDAP and PDCP. The O-CU-CP 230 may be connected to an access and mobility management function (AMF) included in a 5G network (5G core) and an NGAP interface. The O-DU 250 is a logical node that provides functions of RLC, MAC, and high physical layer (high-PHY), and the O-RU 260 connected to the O-DU 250 is a logical node that provides functions of the lower physical layer and RF processing. In FIG. 2, each logical node is shown as a single logical node, but a plurality of logical nodes are also possible. For example, a plurality of O-RUs 260 may be connected to one O-DU 250, and a plurality of O-DUs 250 may be connected to one O-CU-UP 240.

The disclosure is not limited by the name of each node described above, and the configuration of the disclosure may be applied to any logical node or entity that performs the functions described above. In addition, the logical node may be physically located in the same location or a different location, and its function may be provided by the same physical device (e.g., processor, control unit, etc.) or a different physical device. For example, at least one of the functions of the logical node described above may be provided through virtualization in one physical device. Hereinafter, an O-DU may be expressed interchangeably with a DU, and an O-RU may be expressed interchangeably with an RU.

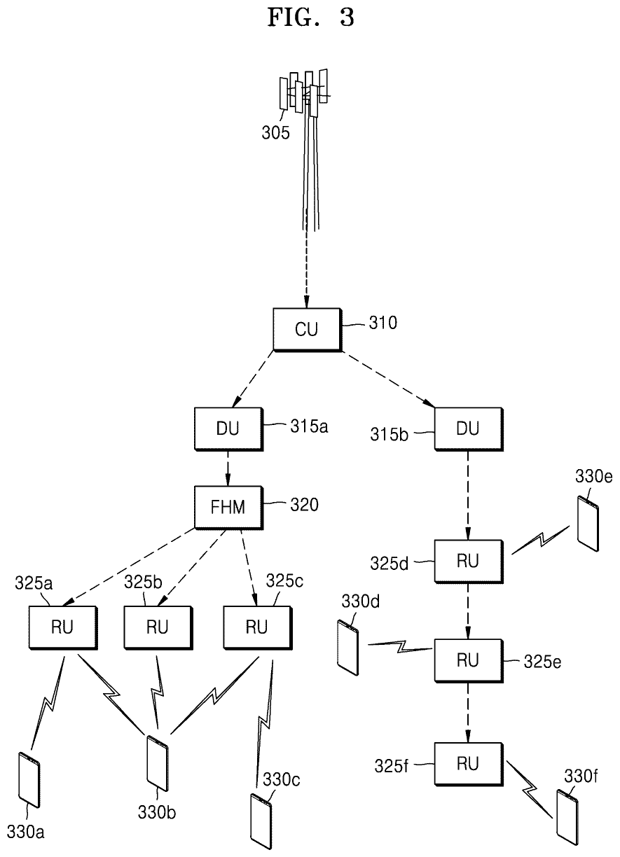

FIG. 3 is a view of a structure of an O-RAN wireless communication system according to an embodiment. The wireless communication system may include a base station 305 and at least one of UEs 330a, 330b, . . . , 330f. The base station may include a CU 310, at least one of DUs 315a and 315b, an FHM 320, and at least one of RUs 325a, 325b, . . . , 325f. The CU, DUs, FHM, and RUs may all be included in a base station or exist as entities with separate functions.

In an embodiment, the wireless communication system may be a radio access network (RAN) such as an O-RAN. The RAN may include connection between UE and a network including a base station. The O-RAN may include all of functions and components within the RAN and may interoperate with other functions or components. Like a traditional RAN structure, the O-RAN may also use a CU/DU split structure. An RU may generally have functions for transmitting, receiving, amplifying, and digitizing a radio frequency signal. In an embodiment, the RU may be located near an antenna and a DU. A CU may be located closer to a core network. An FHM may serve as an interface between the RU and the DU, and may multiplex or demultiplex information received from the RU before providing information to the DU. The CU 310, DU, FHM, and RU may be expressed as O-CU, O-DU, O-FHM, and O-RU, respectively.

In an O-RAN architecture, a shared cell structure may include the RU combining an I/Q sample to an incoming sample before transmitting the I/Q sample from the RU to the DU. In the O-RAN architecture utilizing a CU/DU split, the structure may be defined in two modes.

A first mode is an FHM mode, and the FHM 320 may retrieve compressed information along with the I/Q sample through signaling from all of the O-RUs 325a, 325b, and 325c connected to the FHM 320. A plurality of O-RUs are connected to the FHM, and each RU may be associated with one or more UEs or perform wireless communication.

A second mode may be defined as a cascade mode (or a cascade O-RU mode). The cascade O-RUs 325d and 325e may retrieve compressed information along with the I/Q sample through messaging from a southbound node O-RU (e.g., a trailing O-RU or downstream O-RU). An upstream O-RU may perform combining to transmit the I/Q sample to the next RU or DU.

FIG. 4 is a view of a structure of an Ethernet message according to an embodiment. A destination MAC address 400 in a header of the Ethernet message may indicate a public address of an RU in the case of DL, and may indicate a public address of a specific port of a channel card of a DU (the channel card may perform an MAC layer operation responsible for scheduling, a high-PHY operation, and an operation to convert a data format according to an interface between the RU and the DU) in the case of UL. A source MAC Address 410 may indicate the RU in the case of UL, and may indicate a public address of a specific port of the channel card of the DU in the case of DL.

A virtual LAN (VLAN) Tag 420 has a size of 4 bytes and allows management of C-plane, U-plane, or S-plane messages by mapping them to respective VLAN tags. A tag protocol identifier (TPID) included in the VLAN Tag 420 may be set to 16 bits and may be set to a value of 0x8100 to identify a frame as an IEEE 802.1Q tag frame. This field is located in the same position as that of an Ethertype/Length field in an untagged frame, so it can be used to distinguish an untagged frame from regular frames. Tag control information (TCI) included in the VLAN Tag may also be set to 16 bits and may include the following three fields. Priority code point (PCP) is 3 bits and may express priority of frames. A drop eligible indicator (DEI) may be set to 1 bit and is used separately or in combination with the PCP, and identifies frames that are desirable to be removed when traffic becomes congested. A VLAN identifier (VID) may be set to 12 bits and is a field that indicates which frame a VLAN belongs to. All values except reserved values 0x000 and 0xFFF may be used as VLAN identifiers, and up to 4,094 VLANs may be allowed. The reserved value 0x000 indicates that the frame does not belong to any VLAN. In this case, 802.1Q only specifies a priority and this priority may be referenced as a priority tag. Because Type/Length (Ethertype) is for eCPRI, it can be set to a fixed value of 0xAEFE.

A payload 440 may include a message according to each plane format, including an eCPRI header, as shown in FIG. 4. Content of each field or information of the Ethernet message described in relation to FIG. 4 does not necessarily have to be included all fields, and the disclosure may be performed by omitting the content or/and adding other fieIds as necessary.

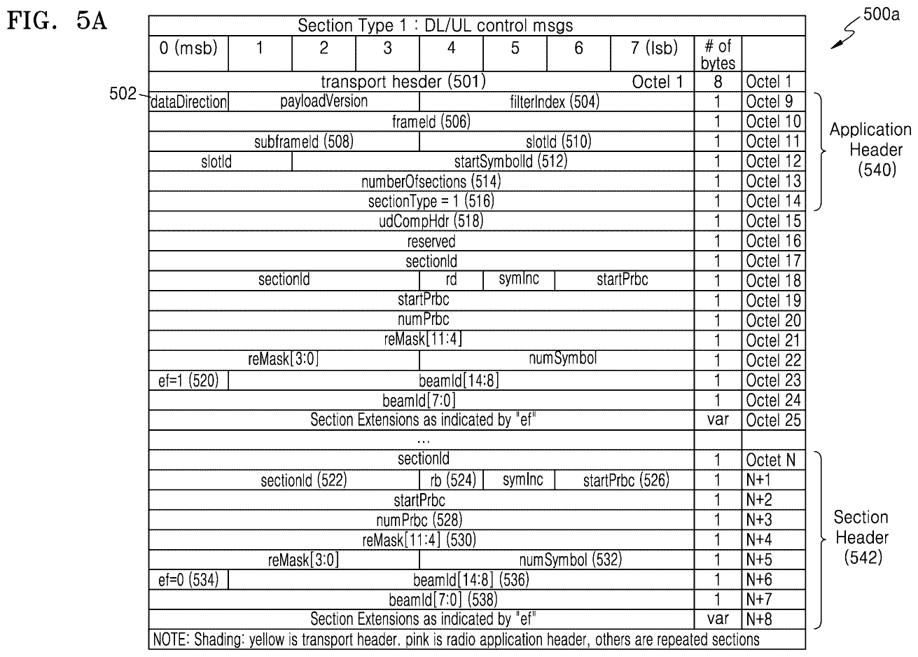

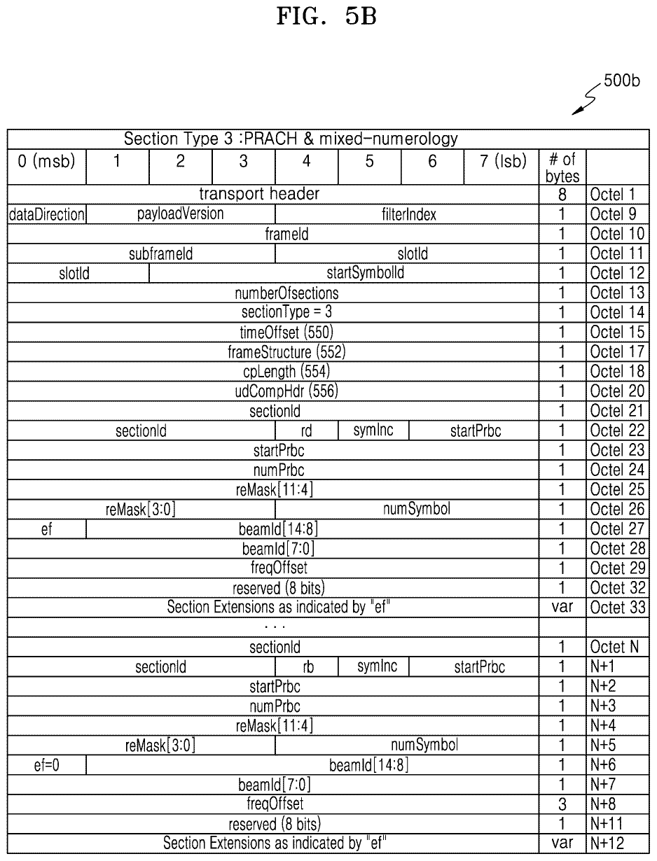

FIGS. 5A and 5B are views illustrating an example of a C-plane message according to an embodiment. FIG. 5A may show a C-plane structure of section type 1, and FIG. 5B may show a C-plane structure of section type 3.

First, looking at each field in FIG. 5A, transport header 501 may include an eCPRI header shown in FIG. 4 or information according to IEEE-1914.3. dataDirection 502 indicates a direction of a U-Plane message, wherein 0 may indicate UL and 1 may indicate a DL. filterIndex 504 indicates a channel filter of an RU and may be set to 0x1. frameId 506 may indicate a specific frame in units of 10 ms. SubframeId 508 may indicate a specific subframe in units of 1 ms within a corresponding frame. slotId 510 may indicate a specific slot within a corresponding frame.

numberOfsections 514 may indicate the number of sections indicated by a corresponding message. In the case of SectionType 516, one C-plane message may have only one section type. In this example, the SectionType 516 may indicate section type 1. udCompHdr 518 may indicate an IQ bit width (bit) and a compression method for IQ data in all sections of a corresponding message. In more detail, upper 4 bits may be iqWidth, indicating 1 to 16 bits, and lower 4 bits may be compMeth, indicating a compression method. 502 to 518 described above are an application header 540 that can be commonly applied to a corresponding message, and may be included in a similar structure in all C-plane messages.

A C-plane message of section type 1 may include information about an arbitrary section. SectionID 522 indicates an ID of the section, which may be used to match a C-plane message and a U-plane message. rb 524 indicates which PRB is used, wherein 0 may indicate that all PRBs are used, and 1 may indicate that one PRB (every other PRB) is used. StartPrbc 526 is used to indicate the first PRB of a corresponding section, and numPrbc 528 may indicate the number of PRBs in a corresponding section. reMask 530 is a bit pattern that indicates an RE (or subcarrier) corresponding to a specific beam in a corresponding PRB, and different beams may be applied within one PRB through reMask. numSymbol 532 may indicate the number of symbols corresponding to the section. The fieIds described above may be referred to as a section header 542 for each section.

In addition, the C-plane message may include section extension, and whether or not the section extension is included may be indicated by ef 520. Content of each field or information described in relation to FIG. 5A does not necessarily have to be included all fields, and the disclosure may be performed by omitting the content or/and adding other fieIds as necessary.

Referring to FIG. 5B, transport header to sectionType are the same as in FIG. 5A, but there is a difference in the next field. Timeoffset 550, framestructure 552, cpLength 554, and udCompHdr 556 are fieIds that can be checked in C-plane of section type 3. Timeoffset 550 defines a time offset from the start of a slot to the start of a cyclic prefix (CP). Framestructure 552 defines a frame structure, where the first 4 bits define the size of FFT/iFFT used for processing all IQ data associated with a C-plane message, and the remaining 4 bits define subcarrier spacing (SPS) and the number of slots per 1 ms subframe. cpLength 554 indicates a length of the cyclic prefix. udCompHdr 556 defines a compression method and an in-phase and quadrature (IQ) bitwidth for user data in a data section. Because most of the other fieIds are similar to those in FIG. 5A, their description will be omitted.

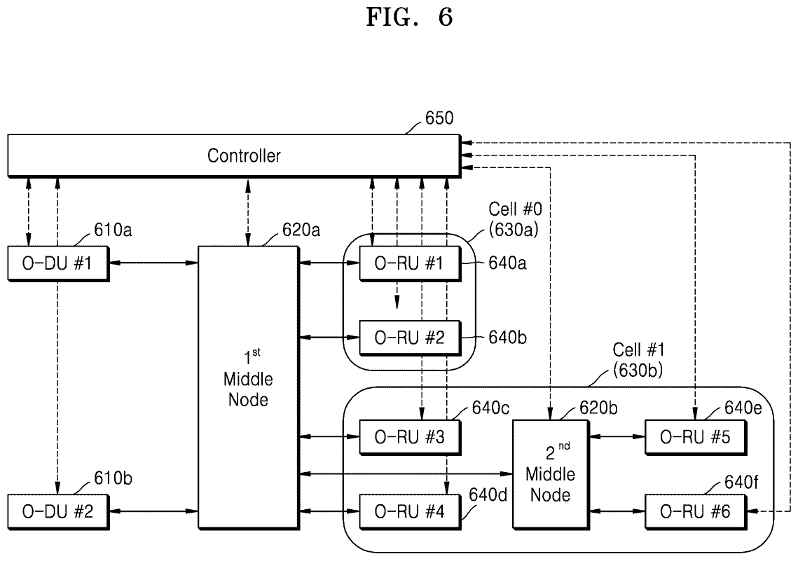

FIG. 6 is a view of a structure of an O-RAN base station including a middle node according to an embodiment of the disclosure.

Referring to FIG. 6, an O-RAN base station (or network) 600 may include at least one of O-DUs 610a and 610b, middle nodes 620a and 620b, at least one of O-RUs 640a, 640b, . . . , 640f, and a controller 650.

The at least one of O-DUs 610a and 610b may also be called a northbound node centered on the first middle node 620a. The middle nodes 620a and 620b may be used interchangeably with an FHM 620a, a cascade FHM (not shown), or a cascade O-RU 620B. The at least one of O-RUs 640a, 640b, . . . , 640f may be used interchangeably with a southbound node centered on the first middle node 620a. The controller 650 may have functions included in the O-DUs 610a and 610b, or may exist as a separate device.

Referring to FIG. 6, the controller 650 may perform direct communication with the at least one of O-DUs 610a and 610b, the middle nodes 620a and 620b, and the at least one of O-RUs 640a, 640b, . . . , 640f. The controller 650 may communicate an M-plane message with the at least one of O-DUs 610a and 610b. The controller 650 may communicate an M-plane message with the middle nodes 620a and 620b. The at least one of O-DUs 610a and 610b may communicate a C/U-Plane message with the middle node 620a. The at least one of O-DUs 610a and 610b may communicate a C/U-Plane message directly with the at least one of O-RUs 640a, 640b, . . . , 640f. The middle node may communicate with at least one O-RU included in at least one of cells (cell #0 and cell #1) 630a and 630b. The first middle node 620a may transmit the M-plane and C/U-plane messages received from the at least one of O-DUs 610a and 610b or the controller 650 to the at least one of O-RUs 640a, 640b, . . . , 640f. At this time, the first middle node 620a may copy an identical message and transmit it to O-RUs included in each of the cells. For example, an identical message may be copied from the first middle node 620a and transmitted to the O-RU #1 640a and the O-RU #2 640b included in the cell #0 630a, respectively. In addition, different messages may be transmitted to the cell #0 630a and the cell #1 630b from the first middle node 620a, respectively. According to an embodiment, the second middle node 620b may be included inside the cell #1 630b. In this case, the second middle node 620b may include an O-RU southbound from the second middle node 620b, and may copy and transmit a message sent from an upper level to the O-RU. For example, the cell #1 630b includes the second middle node 620b, and the second middle node 620b may copy and transmit data received from the first middle node 620a to the O-RU #5 640e and the O-RU #6 640f located southbound.

Referring to FIG. 6, the at least one of O-RUs 640a, 640b, . . . , 640f may transmit a U-plane message to the first middle node 620a based on data received from a terminal. The first middle node 620a may combine messages received from the at least one of O-RUs 640a, 640b, . . . , 640f. Here, the term “combine” may include expressions such as combine, sum, aggregate, and add. The first middle node 620a may combine messages received from the at least one of O-RUs 640a, 640b, . . . , 640f and transmit them to the at least one of O-DUs 610a and 610b. At this time, the first middle node 620a may perform combining on data received from O-DUs included in an identical cell. According to an embodiment, the middle node 620b may be included inside the cell 630b. In this case, the second middle node 620b includes an O-RU southbound from the second middle node 620b, and may combine messages received from the O-RU and transmit them to an upper level. For example, according to a cascade structure in the cell #1 630b, the second middle node 620b may combine data received from the O-RU #5 640e and the O-RU #6 640f located at a lower level and transmit the data to the first middle node 620a at an upper level. Here, the term “combine” may include expressions such as combine, sum, aggregate, and add. The first middle node 620a may combine data received from the second middle node 620b and data received from the O-RU #3 640c and the O-RU #4 640d included in the cell #1 630b and transmit the data to the O-DUs 610a and 610b.

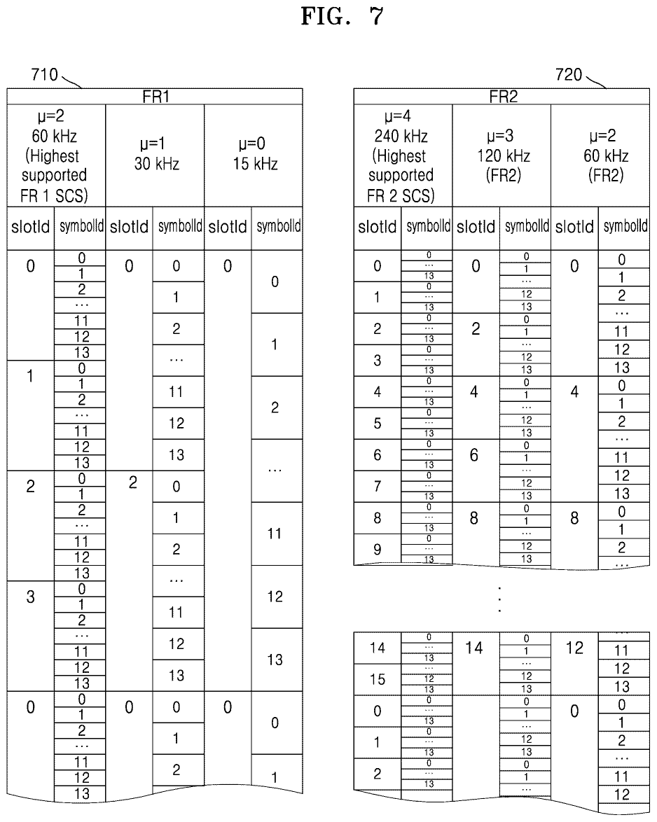

FIG. 7 is a table of a slot ID index according to an embodiment of the disclosure.

FIG. 7 may represent information about mapping of a slot identifier (slotld) and a symbol identifier (symbolId) that can be supported by an O-RU according to a frequency range.

Numerology most likely to be supported by an O-RU in a given frequency range FR1 710 or FR2 720 may be used as a common reference (separately for FR1 and FR2) for a start of a slot identified by SlotId. In a communication system, UL and DL need to use the same reference numerology for SlotId. If the numerology most likely to be supported by the O-RU allows both normal CP and extended CP, normal CP may be used as a reference. Symbol duration and time position may be calculated from a value (which may be configured via subcarrier spacing (SCS) of a message field or via an M-Plane) and a SlotId field of a C/U-Plane message. A sectionId field value of the C/U-Plane message addressed to each eAxC needs to be unique for each slot identified by a SlotId value.

Referring to FIG. 7, for the FR1 710, maximum SCS supported by the O-RU is 60 kHz, and in this case, the maximum number of slots per subframe may be 4. Therefore, slotIds may be configured as 0, 1, 2, and 3, and 14 symbolIds may be mapped to each slotld. In addition, when the FR1 710 supports 15 kHz, 30 kHz, and 60 kHz, values are 0, 1, and 2, respectively, and slotIds may be configured as 0/0, 2/0, 1, 2, 3, respectively.

For the FR2 720, the maximum SCS supported by the O-RU is 240 kHz, and in this case, the maximum number of slots per subframe may be 16. Therefore, slotIds may be configured as 0 to 15, and 14 symbolIds may be mapped to each slotld. In addition, when FR2 720 supports 60 kHz, 120 kHz, and 240 kHz, values are 2, 3, and 4, respectively, and slotIds may be configured as 0, 4, 8, 12/0, 2, 4, 6, 8, 10, 12, 14/0, 1, 2, 3, . . . , 15, respectively.

However, in this case, both the FR1 710 and the FR2 720 support 60 kHz, but different slotIds may be configured because the maximum supported SCSs are different. For example, FR1 has slotIds configured as 0, 1, 2, and 3 at 60 kHz, but FR2 has slotIds configured as 0, 4, 8, and 12 at 60 kHz, which are different.

This may cause problems in an embodiment when the O-RUs are included in a shared cell. In fronthaul communication between O-DU and O-RU, in the case of shared cell, identical configuration information needs to be included in a message and transmitted. However, in the case where O-RUs included in a shared cell include different frequency ranges such as FR1 and FR2, an O-DU needs to transmit an identical message, but due to different slotId configurations, O-RUs with the same configuration may operate, but O-RUs with different configurations cannot identify the message and do not operate.

Furthermore, even in the case where a plurality of O-RUs are not included in a shared cell, when a DU configures multiple cells for the O-RUs, respectively, processing capacity of an O-DU may be increased by configuring a unified slotId instead of configuring slotId for each O-RU. Therefore, in general fronthaul communication, a method of configuring slotId is required in terms of reducing communication efficiency and computational load.

In conclusion, in order to configure multiple cells or shared cells in fronthaul communication, a method for unifying slotId configurations of O-RUs is required.

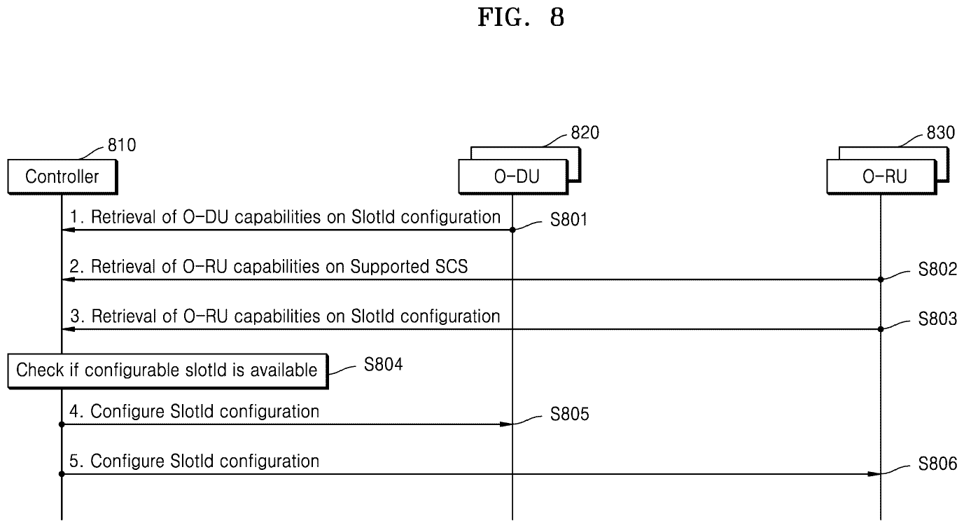

FIG. 8 is a view illustrating a method of configuring slot identifier (slotld) configuration according to an embodiment of the disclosure.

A controller 810 of FIG. 8 is composed of at least one O-DU 820 and at least one O-RU 830, and the controller 810 may be configured to exist as a separate entity or exist within the O-DU, which is identical to or similar to the controllers in FIGS. 1A to 6.

In operation S801, the controller 810 may request SlotId configuration capability information (capabilities on SlotId configuration) from at least one O-DU (or an O-DU) 820. The O-DU 820 may transmit the SlotId configuration capability information via an M-Plane message when requested from the controller 810. According to another embodiment, the O-DU 820 may periodically transmit SlotId configuration capability information that is configured in advance to the controller 810.

In operation S802, the controller 810 may request at least one O-RU (or an O-RU) 830 configuring a cell for supported SCS capability information (capabilities on supported SCS). The O-RU 830 may transmit the supported SCS capability information via an M-Plane message when requested from the controller 810. According to another embodiment, the O-RU 830 may periodically transmit supported SCS capability information that is configured in advance to the controller 810. For example, in the case of O-RU of the FR1 710 of FIG. 7, the O-RU 830 may transmit information indicating that the O-RU 830 may support SCSs of 15 kHz, 30 kHz, and 60 kHz to the controller 810.

In operation S803, the controller 810 may request SlotId configuration capability information (capabilities on SlotId configuration) from the at least one O-RU 830 configuring a cell. The O-RU 830 may transmit the SlotId configuration capability information via an M-Plane message when requested from the controller 810. According to another embodiment, the O-RU 830 may periodically transmit SlotId configuration capability information that is configured in advance to the controller 810.

Here, the SlotId configuration capability information may include information indicating whether a communication node may perform slotId configuration (or change) (Configurable-SlotId-Supported) and information indicating the scope of application of the slotId configuration (Configurable-slotId-granularity). The SlotId configuration capability information may be expressed as in Table 2 below.

TABLE 2

| | |
|---|---|
| Configurable-SlotId-Supported | True/false |
| Configurable-slotId-granularity | O-RU/Transport-flow/Endpoint |

A Configurable-SlotId-Supported field may indicate whether a corresponding communication node may change currently configured slotId configuration according to an instruction of a controller. Here, information indicating whether slotId configuration is possible may be included in the form of configurable-SlotId supported Flag (Boolean type=true) in a YANG model. The configurable-SlotId supported field may include information of True if SlotId configuration is possible, and may include information of False if SlotId configuration is not possible. If False or corresponding leaf does not exist in a message, the corresponding communication node supports a slotId value according to a current specification (e.g., slotld configured according to the maximum SCS supported by the corresponding communication node).

A Configurable-slotId-granularity field may be information indicating a unit to which corresponding configuration information is applied when the corresponding communication node configures slotId. The Configurable-slotId-granularity field may be divided into 0-RU level, transport-flow level, and endpoint level. The O-RU level may indicate that one O-RU data flow configures one SlotId step per SCS, the transport-flow level may indicate that one SlotId step is configured per SCS per transport flow (i.e., per O-DU), and the endpoint level may indicate that one SlotId step is configured per SCS per endpoint (i.e., per data flow).

In operation S804, the controller 810 may determine whether slotId configuration is possible based on slotId configuration capability information received from communication nodes O-DU and O-RU and supported SCS capability information in operations S801 to S803. Furthermore, if the controller 810 determines that slotId configuration is possible, an increment value of a slotld value may be set for each SCS within one subframe. For example, the controller 810 may set the increment value of the slotId value as shown in Table 3.

TABLE 3

| SCS | 15 kHz | 30 kHz | 60 kHz | 120 kHz | 240 kHz | 480 kHz | 960 kHz |
|---|---|---|---|---|---|---|---|
| n | No need | 0 | 0, 1, 2, 3 | 0, 1, 2 | 0, 1 | 0 | 0 |
| step | | 1 | 1, 2, 4, 8 | 1, 2, 4 | 1, 2 | 1 | 1 |

The controller 810 may set an increment value of a slotId value for each SCS based on Table 3. The calculation method is as follows:

Step=2n, n={0, 1, 2, 3, 4}. [Equation 1]

The controller 810 may generate SlotId configuration information based on the above information. The SlotId configuration information may be configured in a format as shown in Table 4.

TABLE 4

| SlotId- | Id | | Unsigned integer |
|---|---|---|---|
| config | slotId-increment- | SCS | 15 kHz, 30 kHz, . . . |
| | per-SCS | slotId-increment | Unsigned integer, |
| | | | 0/1/2/3/4 |

The controller 810 may generate slotId configuration information based on Table 4. Here, slotId increment may be determined according to Equation 2.

SlotId increment=2n, n={0, 1, 2, 3, 4} [Equation 2]

For example, if SCS is 60 kHz, if n=0, slotIds may be determined as 0, 1, 2, and 3, and if SCS is 120 kHz, if n=1, slotIds may be determined as 0, 2, 4, 8, 10, 12, and 14.

The controller 810 may generate slotId configuration information to change slotld configuration for an O-RU that reports that slotId configuration is possible after receiving slotld configuration capability information from a plurality of O-RUs. For example, in the case of a shared cell, if a first O-RU supports slotId configuration capability (True) but a second O-RU does not support slotId configuration capability (False), slotId configuration information may be generated to allow the first O-RU to change slotId configuration. Furthermore, in the case where all of O-RUs support slotId configuration capability and multiple cells are configured, an O-DU may generate slotId configuration information according to SCS that is determined to enable optimal communication.

According to an embodiment, different slotId configuration information may be generated for each O-RU by considering the Configurable-slotId-granularity field received in operations S801 to S803.

In operation S805, the controller 810 may transmit SlotId configuration information (slotld configuration) configured in operation S804 to the O-DU 820. The O-DU 820 that has received the SlotId configuration information may use configured slotId when performing communication with at least one connected O-RU 830.

In operation S806, the controller 810 may transmit the SlotId configuration information (slotId configuration) configured in operation S804 to the at least one O-RU 830 configuring a cell. The O-RU 830 that has received the SlotId configuration information may use configured slotld when performing communication with the connected O-DU 820.

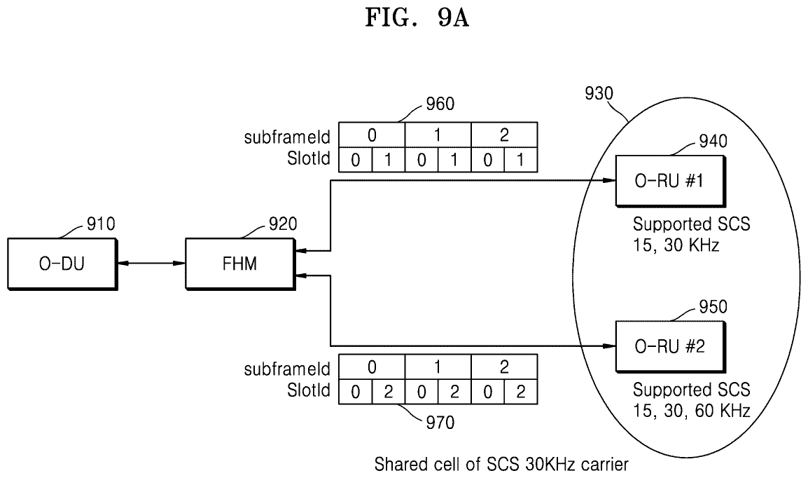

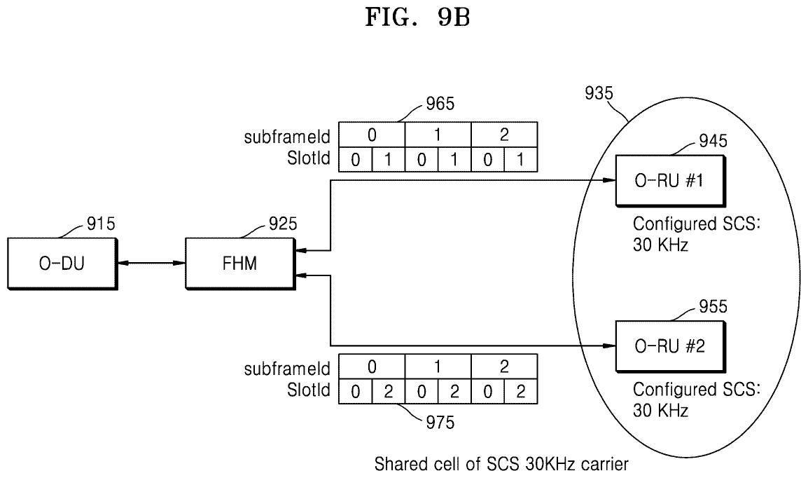

FIG. 9A is a view illustrating a method of performing fronthaul communication in a shared cell according to an embodiment of the disclosure. FIG. 9B is a view illustrating a method of performing communication in a shared cell through slotId configuration, according to another embodiment of the disclosure.

An O-DU 910, a middle node (FHM) 920, a first O-RU 940, and a second O-RU 950 of FIGS. 9A and 9B may be the same as the controller, the O-DU, the middle node, and the at least one O-RU of FIGS. 1A to 8. In FIGS. 9A and 9B, the O-DU 910 may include a controller.

Referring to FIG. 9A, the O-DU 910 may perform fronthaul communication with the a plurality of O-RUs 940 and 950 included in a shared cell 930 through the middle node (e.g., FHM) 920. Here, there may be a problem because SCSs supported by the first O-RU 940 and the second O-RU 950 included in an identical shared cell are different. For example, the first O-RU 940 may support SCSs of 15 kHz and 30 kHz, and the second O-RU 950 may support SCSs of 15 kHz, 30 kHz, and 60 kHz. In this case, SlotId for each O-RU is configured according to the maximum size of SCS that can be supported. Therefore, for the first O-RU 940, slotId 960 of SCS of 30 kHz is determined as 0 and 1, and for the second O-RU 950, slotId 970 of SCS of 30 kHz is determined as 0 and 2. However, the O-DU 910 cannot send respective slotIds to the first O-RU 940 and the second O-RU 950 included in an identical shared cell (violation of a copy operation), and thus cannot configure a shared cell with a current standard.

FIG. 9B illustrates an example of performing fronthaul communication using unified slotld through slotId configuration, according to an embodiment of the disclosure.

Referring to FIG. 9B, an O-DU 915 may perform fronthaul communication with a plurality of O-RUs 945 and 955 included in a shared cell 935 through a middle node (e.g., FHM) 925. Here, as in FIG. 9A, SCSs supported by the third O-RU 945 and the fourth O-RU 955 included in an identical shared cell are different, which may be a problem. However, slotId configuration may be performed based on the method described in FIG. 8. The O-DU 915 may receive SCS capability information and slotId configuration capability information supported by each of the O-RUs 945 and 955. The O-DU 915 may generate slotId configuration information based on the received SCS capability information and slotId configuration capability information. In FIG. 9B, the slotld configuration information may be generated so that slotId is configured as 0 and 1 to match a 30 kHz shared cell or 30 kHz, which is the maximum supported SCS of the third O-RU 945. The O-DU 915 may transmit the generated slotId configuration information to each of the O-RUs 945 and 955 through the middle node 925. The third O-RU 945 may perform operations on messages later because the received slotId configuration information is identical to the existing slotld configuration of the third O-RU 945, and the fourth O-RU 955 may change slotId configuration so that slotId may be configured as 0 and 1 like the third O-RU 945 because the fourth O-RU 955 has slotId configuration capability and the received slotId configuration information is included in SCS supported by the fourth O-RU 955. Thereafter, the O-DU 915 may transmit an identical message to the O-RUs 945 and 955 included in the shared cell 935, and the O-RUs 945 and 955 with unified slotIds according to slotId configuration may receive messages from the O-DU 915 and perform operations.

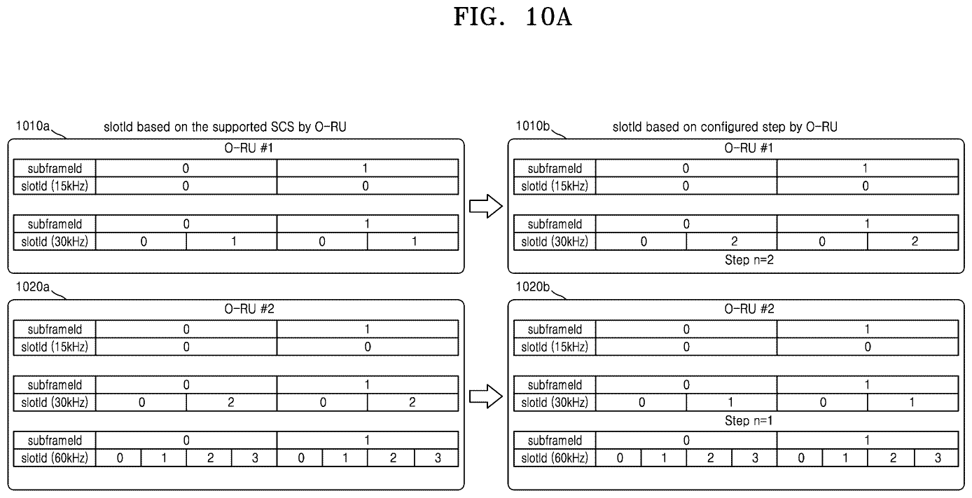

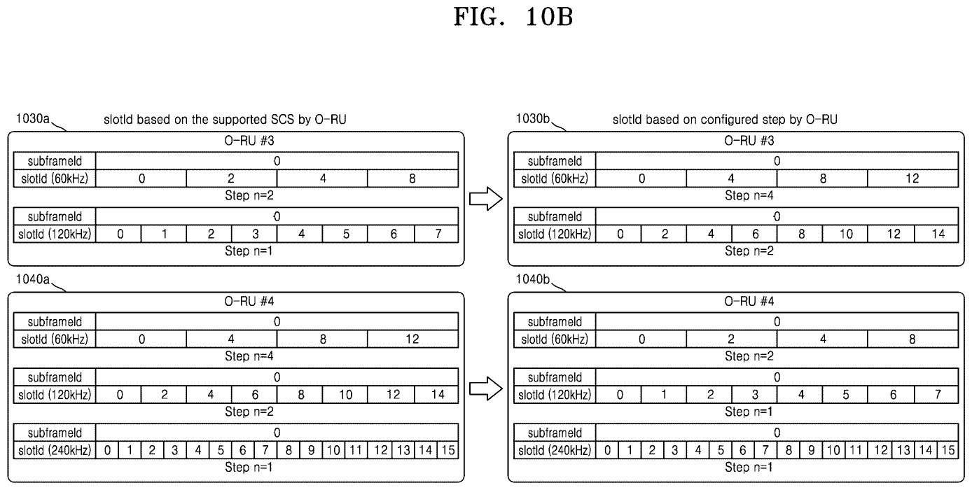

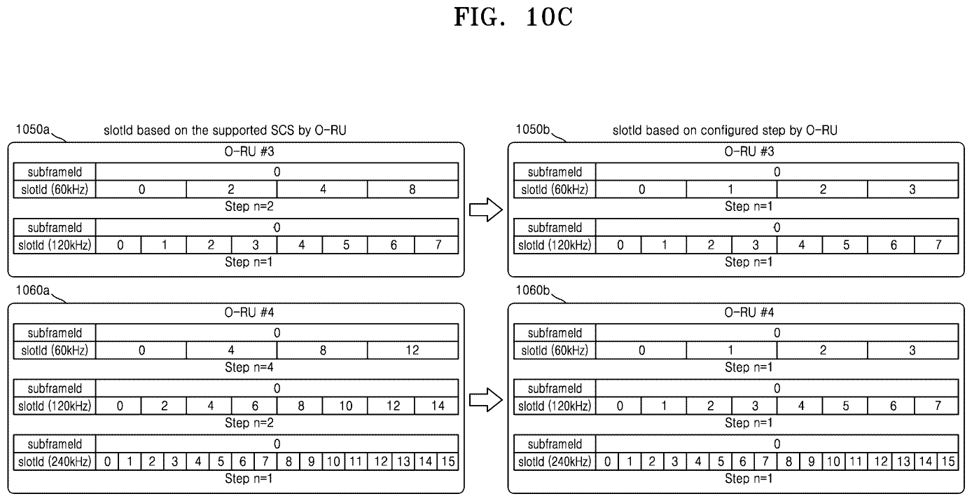

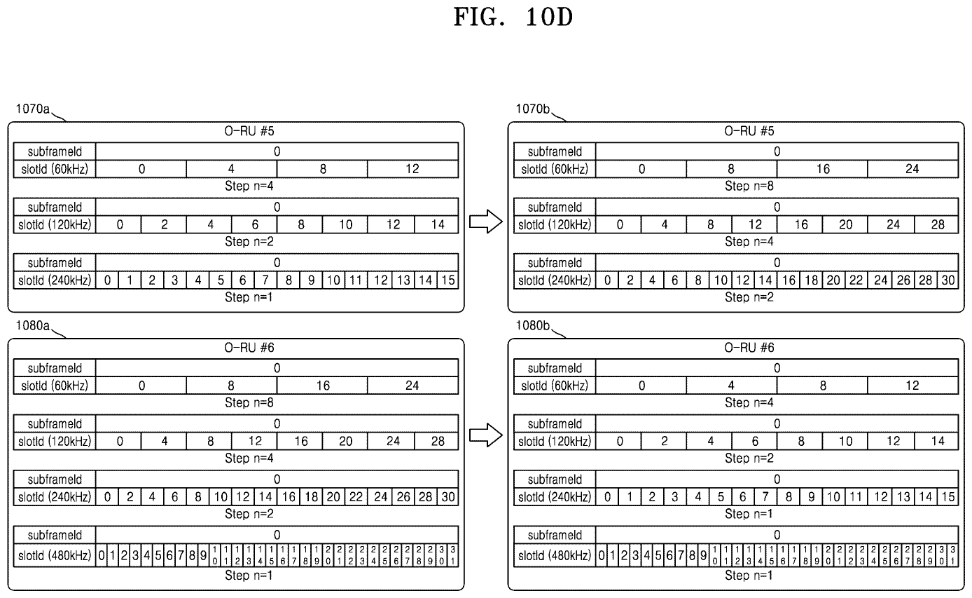

FIG. 10A is a view illustrating a first embodiment of applying slotId configuration according to an embodiment of the disclosure. FIG. 10B is a view illustrating a second embodiment of applying slotId configuration according to an embodiment of the disclosure. FIG. 10C is a view illustrating a third embodiment of applying slotId configuration according to an embodiment of the disclosure. FIG. 10D is a view illustrating a fourth embodiment of applying slotId configuration according to an embodiment of the disclosure.

O-RUs of FIGS. 10A to 10D may be the same as the O-RUs of FIGS. 1A to 9B.

Referring to FIG. 10A, a first O-RU and a second O-RU are included in an identical shared cell. The first O-RU supports SCSs of 15 kHz and 30 kHz, and because the maximum supported SCS is 30 kHz, slotId 1010a for 30 kHz may be configured as 0 and 1. The second O-RU supports SCSs of 15 kHz, 30 kHz, and 60 kHz, and because the maximum supported SCS is 60 kHz, slotId 1020a for 30 kHz may be configured as 0 and 2. In this case, slotId configuration may be required. Therefore, each O-RU may transmit slotId configuration capability information and supported SCS information to a controller, and receive slotId configuration information from the controller. A first method is a method in which the first O-RU changes slotId configuration. This case may be the case when the second O-RU does not support slotId change. In this case, the first O-RU may change slotId configuration 1010b of 30 kHz to 0 and 2. A second method is a method in which the second O-RU changes slotId configuration. This may be the case when the first O-RU does not support slotId change or when the shared cell is configured as 30 kHz. In this case, the second O-RU may change slotId configuration 1020b of 30 kHz to 0 and 1.

Referring to FIG. 10B, a third O-RU and a fourth O-RU are included in an identical shared cell. The third O-RU supports SCSs of 60 kHz and 120 kHz, and because the maximum supported SCS is 120 kHz, slotId for 60 kHz may be configured as 0, 2, 4, and 8, and slotId 1030a for 120 kHz may be configured as 0 to 7. The fourth O-RU supports SCSs of 60 kHz, 120 kHz, and 240 kHz, and because the maximum supported SCS is 240 kHz, slotId 1040a for 60 kHz may be configured as 0, 4, 8, and 12, and slotId for 120 kHz may be configured as 0, 2, 4, . . . , 14. In this case, slotId configuration may be required. Therefore, each O-RU may transmit slotld configuration capability information and supported SCS information to a controller, and receive slotId configuration information. A first method is a method in which the third O-RU changes slotId configuration. This case may be the case when the fourth O-RU does not support slotld change. In this case, the third O-RU may change slotId configuration 1030b of 60 kHz to 0, 4, 8, and 12, and slotId configuration of 120 kHz to 0, 2, 4, . . . , 14. A second method is a method in which the fourth O-RU changes slotId configuration. This may be the case when the third O-RU does not support slotId change or when the shared cell is configured as 120 kHz. In this case, the fourth O-RU may change slotId configuration 1040b of 60 kHz to 0, 2, 4, and 8, and slotld configuration of 120 kHz to 0 to 7.

Referring to FIG. 10C, the third O-RU and the fourth O-RU are included in an identical shared cell. FIG. 10C illustrates a method of performing slotId configuration in a different way in a similar situation as FIG. 10B. The third O-RU supports SCSs of 60 kHz and 120 kHz, and because the maximum supported SCS is 120 kHz, slotId for 60 kHz may be configured as 0, 2, 4, and 8, and slotId 1050a for 120 kHz may be configured as 0 to 7. The fourth O-RU supports SCSs of 60 kHz, 120 kHz, and 240 kHz, and because the maximum supported SCS is 240 kHz, slotld 1060a for 60 kHz may be configured as 0, 4, 8, and 12, and slotId for 120 kHz may be configured as 0, 2, 4, . . . , 14. In this case, slotId configuration may be required. Therefore, each O-RU may transmit slotId configuration capability information and supported SCS information to a controller, and receive slotId configuration information. In the case of FIG. 10C, unlike FIG. 10B, slotld configuration of each O-RU is not changed to match slotId configuration of another O-RU, but is unified to third slotId configuration. In this case, the third O-RU may change slotId configuration 1050b of 60 kHz to 0, 1, 2, and 3, and slotId configuration of 120 kHz to 0 to 7. In addition, the fourth O-RU may change slotId configuration 1060b of 60 kHz to 0, 1, 2, and 3, and slotld configuration of 120 kHz to 0 to 7.

Referring to FIG. 10D, a fifth O-RU and a sixth O-RU are included in an identical shared cell. The fifth O-RU supports SCSs of 60 kHz, 120 kHz, and 240 kHz, and because the maximum supported SCS is 240 kHz, slotId 1070a for 60 kHz may be configured as 0, 4, 8, and 12, slotld for 120 kHz may be configured as 0, 2, 4, . . . , 14, and slotId for 240 kHz may be configured as 0 to 15. The sixth O-RU supports SCSs of 60 kHz, 120 kHz, 240 kHz, and 480 kHz, and because the maximum supported SCS is 480 kHz, slotId 1080a for 60 kHz may be configured as 0, 8, 16, and 24, slotId for 120 kHz may be configured as 0, 4, 8, . . . , 28, slotId for 240 kHz may be configured as 0, 2, 4, . . . , 30, and slotId for 480 kHz may be configured as 0 to 31. In this case, slotld configuration may be required. Therefore, each O-RU may transmit slotId configuration capability information and supported SCS information to a controller, and receive slotId configuration information. A first method is a method in which the fifth O-RU changes slotId configuration. This case may be the case when the sixth O-RU does not support slotId change. In this case, the fifth O-RU may change slotId configuration 1070b of 60 kHz to 0, 8, 16, and 24, slotId configuration of 120 kHz to 0, 4, 8, . . . , 28, and slotId configuration of 240 kHz to 0, 2, 4, . . . , 30. A second method is a method in which the sixth O-RU changes slotId configuration. This may be the case when the fifth O-RU does not support slotId change or when the shared cell is configured as 2400 kHz. In this case, the sixth O-RU may change slotId configuration 1080b of 60 kHz to 0, 4, 8, and 12, slotId configuration of 120 kHz to 0, 2, 4, . . . , 14, and slotId configuration of 240 kHz to 0 to 15.

FIGS. 10A to 10D merely illustrate several embodiments according to the methods of the disclosure, and actual usage examples are not limited to the embodiments, and it goes without saying that the embodiments can be utilized in various ways according to a frequency range of an O-RU depending on the situation.

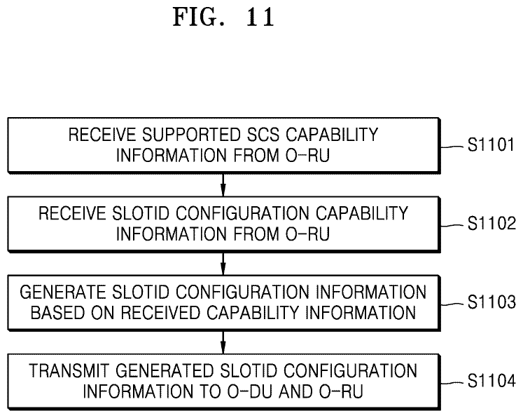

FIG. 11 is a flowchart illustrating a method of configuring slotId according to an embodiment of the disclosure.

FIG. 11 may be operations performed by a controller, O-DU, and O-RU, respectively, as described in FIGS. 1A to 10D and FIG. 12.

In operation S1101, the controller may receive SCS capability information from the O-RU. According to an embodiment, the controller may request SCS capability information from the O-RU and receive SCS capability information in response to the request. Alternatively, the O-RU may periodically transmit SCS capability information to the controller. The SCS capability information may include information about SCS supported by the O-RU.

In operation S1102, the controller may receive SlotId configuration capability information from the O-RU. According to an embodiment, the controller may request SlotId configuration capability information from the O-RU and receive SlotId configuration capability information in response to the request. Alternatively, the O-RU may periodically transmit SlotId configuration capability information to the controller. The SlotId configuration capability information may include information indicating whether the O-RU may change slotId configuration.

In operation S1103, the controller may generate SlotId configuration information based on the pieces of capability information received in operations S1101 and S1102. The controller may identify whether, among the received slotId configuration capability information, slotld configuration capability information of at least one O-RU from among a plurality of O-RUs includes information indicating that slotId can be changed. If the slotId configuration capability information of the at least one O-RU includes information indicating that slotId can be changed, the controller may generate slotId configuration information based on SCS capability information of another O-RU, in which the slotId configuration capability information includes information indicating that slotId cannot be changed.

In operation S1104, the controller may transmit the generated slotId configuration information to the O-DU and the O-RU. The O-RU may change slotId configuration based on the received slotId configuration information. The O-DU and O-RU may perform fronthaul communication based on the received slotId configuration information.

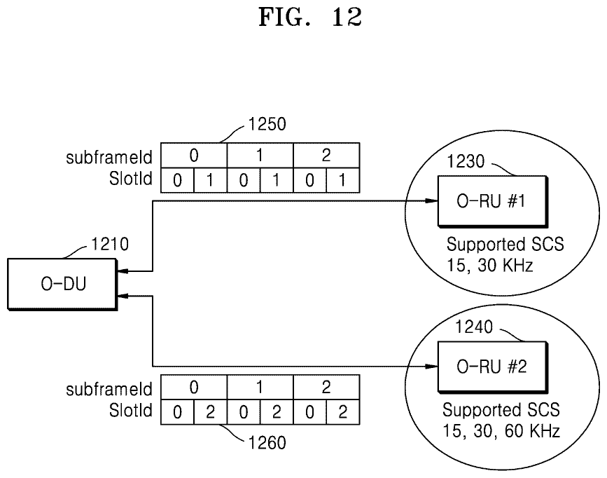

FIG. 12 is a view illustrating a method of performing communication with O-RUs constituting multiple cells through slotId configuration, according to an embodiment of the disclosure.

An O-DU 1210, a first O-RU 1230, and a second O-RU 1240 of FIG. 12 may be the same as the controller, the O-DU, and the at least one O-RU of FIGS. 1A to 6 and FIG. 8. In FIG. 12, the O-DU 1210 may include a controller.

Referring to FIG. 12, the O-DU 1210 may perform fronthaul communication with the O-RUs 1230 and 1240 that each constitute a cell. Here, SCSs supported by the first O-RU 1230 and the second O-RU 1240 may be different. For example, the first O-RU 1230 may support SCSs of 15 kHz and 30 kHz, and the second O-RU 1240 may support SCSs of 15 kHz, 30 kHz, and 60 kHz. In this case, SlotId for each O-RU is configured according to the maximum size of SCS that can be supported. Therefore, for the first O-RU 1230, slotId 1250 of SCS 30 kHz is determined as 0 and 1, and for the second O-RU 1240, slotId of SCS 30 kHz is determined as 0 and 2. However, when the O-DU 1210 sends messages with different slotIds to the first O-RU 1230 and the second O-RU 1240, respectively, there is a problem that resources are wasted and the computational load increases because a separate operation is required for each message.

Therefore, slotId configuration may be performed based on the method described in the disclosure. The O-DU 1210 may receive SCS capability information and slotId configuration capability information supported by each of the O-RUs 1230 and 1240. The O-DU 1210 may generate slotId configuration information based on the received SCS capability information and slotId configuration capability information. The O-DU 1210 may generate slotId configuration information so that slotId is configured as 0 and 1 to match 30 kHz, which is the maximum supported SCS of the first O-RU 1230, considering fronthaul communication status. For example, the O-DU 1210 may generate slotId configuration information with slotId configuration that is included in the most O-RUs from among a plurality of O-RUs connected to the O-DU 1210. Alternatively, the O-DU 1210 may generate slotId configuration information in a way that maximizes communication quality. The O-DU 1210 may transmit the generated slotld configuration information to each of the O-RUs 1230 and 1240. The first O-RU 1230 may perform operations on messages received from the O-DU later because the received slotId configuration information is identical to the existing slotId configuration of the first O-RU 1230, and the second O-RU 1240 may change slotId configuration so that slotId may be configured as 0 and 1 like the first O-RU 1230 because the second O-RU 1240 has slotId configuration capability and the received slotId configuration information is included in SCS supported by the second O-RU 1240. Thereafter, the O-DU 1210 may transmit messages with the same slotId configuration to the O-RUs 1230 and 1240 without separate operations, and the O-RUs 1230 and 1240 with unified slotIds according to slotId configuration may receive messages from the O-DU 1210 and perform operations.

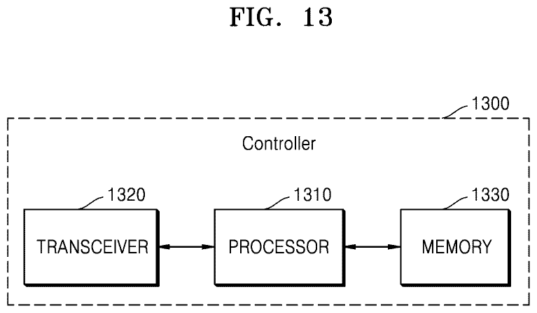

FIG. 13 is a view of a configuration of a controller according to an embodiment of the disclosure.

The controller in FIG. 12 is the same as the controllers or O-DUs described in FIGS. 1A to 12 and may be configured to perform the same or similar operations.

According to an embodiment, in a controller 1300, functions may be included in one device, or each function may be divided into each device.

The controller 1300 according to an embodiment of the disclosure may include a control device (or processor) 1310 that controls operations of the controller, a transceiver (or transceiver unit) 1320 including a transmitter and a receiver, and a memory 1330. However, the disclosure is not limited to the above example, and the controller 1300 may include more or fewer components than those shown in FIG. 13.

According to an embodiment of the disclosure, the transceiver unit 1320 may transmit and receive signals to and from other network nodes (e.g., southbound node, northbound node, O-RU, O-DU, middle node, or upper network entity). Signals transmitted and received to and from the controller may include C-plane, U-plane, S-plane and M-plane signals, uplink data, and downlink data. In addition, the transceiver unit 1320 may receive a signal through a wireless path or a wired path such as a fiber and transmit it to the processor 1310, and transmit a signal determined and output from the processor 1310 through the path.

According to an embodiment of the disclosure, the processor 1310 may control a controller device to perform the operation of any one of the embodiments of FIGS. 1A to 12. Meanwhile, the processor 1310, the memory 1330, and the transceiver unit 1320 do not necessarily have to be implemented as separate modules, and may be implemented as one component in the form of a single chip. In addition, the processor 1310, the memory 1330, and the transceiver unit 1320 may be electrically connected to each other. Furthermore, the processor 1310 may be an application processor (AP), a communication processor (CP), a circuit, an application-specific circuit, or at least one processor.

According to an embodiment of the disclosure, the memory 1330 may store data such as basic programs, applications, and configuration information for the operation of the controller 1300. In addition, the memory 1130 may store uplink and downlink data received by the controller. In particular, the memory 1330 may provide stored data in response to a request from the processor 1310. The memory 1330 may be composed of a storage medium such as read-only memory (ROM), random-access memory (RAM), hard disk, CD-ROM, and digital video disk (DVD), or a combination of storage media. In addition, there may be a plurality of memories 1330. In addition, the processor 1310 may perform the embodiments described above based on a program for performing the embodiments of the disclosure described above stored in the memory 1330.

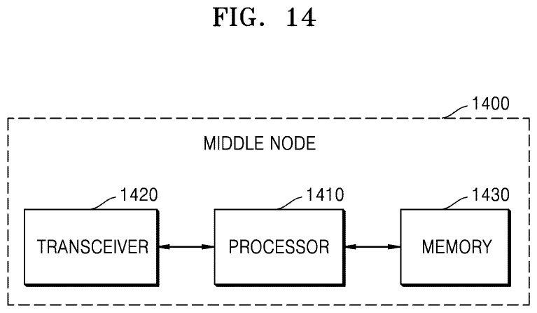

FIG. 14 is a view of a configuration of a middle node according to an embodiment of the disclosure.

The middle node in FIG. 14 is the same as the middle node (FHM, cascade FHM, or cascade O-RU) described in FIGS. 1A to 12 and may be configured to perform the same or similar operations.

According to an embodiment of the disclosure, a middle node 1400 may include the middle node (FHM or cascade O-RU) described in FIGS. 1A to 12. In the middle node, functions may be included in one device or divided into respective devices.

The middle node 1400 according to an embodiment of the disclosure may include a control device (or processor) 1410 that controls operations of the middle node, a transceiver (or transceiver unit) 1420 including a transmitter and a receiver, and a memory 1430. However, the disclosure is not limited to the above example, and the middle node 1400 may include more or fewer components than those shown in FIG. 14.

According to an embodiment of the disclosure, the transceiver unit 1420 may transmit and receive signals to and from other network nodes (e.g., southbound node, northbound node, O-DU, O-RU, controller, or other middle nodes). Signals transmitted and received to and from the middle node may include C-plane, U-plane, S-plane and M-plane signals, uplink data, and downlink data. In addition, the transceiver unit 1420 may receive a signal through a path such as a fiber and transmit it to the processor 1410, and transmit a signal determined and output from the processor 1410 through the path.

According to an embodiment of the disclosure, the processor 1410 may control a middle node device to perform the operation of any one of the embodiments of FIGS. 1A to 12. Meanwhile, the processor 1410, the memory 1430, and the transceiver unit 1420 do not necessarily have to be implemented as separate modules, and may be implemented as one component in the form of a single chip. In addition, the processor 1410, the memory 1430, and the transceiver unit 1420 may be electrically connected to each other. Furthermore, the processor 1410 may be an application processor (AP), a communication processor (CP), a circuit, an application-specific circuit, or at least one processor. The processor 1410 of the middle node 1400 may include a combiner, a copier, a pager, a trigger generator, and a parser to perform operations. Each function may be included in a separate device or may be included together in the processor 1410. The processor may be controlled to perform operations of a combiner, copier, pager, trigger generator, and parser. The parser may analyze received C/U, M, and S-plain messages and identify information included in the messages. The trigger generator may calculate symbol timing or generate combining timing or a combination trigger based on the identified information. The pager may call uplink data stored in the memory corresponding to the generated trigger. The combiner may combine the called data.

According to an embodiment of the disclosure, the memory 1430 may store data such as basic programs, applications, and configuration information for the operation of the middle node. In addition, the memory 1130 may store uplink and downlink data received by the middle node. In particular, the memory 1430 may provide stored data according to a call from the processor 1410. The memory 1430 may be composed of a storage medium such as ROM, RAM, hard disk, CD-ROM, and DVD, or a combination of storage media. The memory 1430 may include at least one buffer for temporarily storing uplink data or downlink data. In addition, there may be a plurality of memories 1430. In addition, the processor 1410 may perform the embodiments described above based on a program stored in the memory 1430 for performing the embodiments of the disclosure described above.

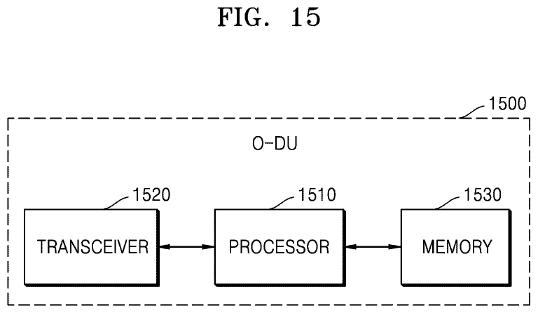

FIG. 15 is a view of a configuration of an O-DU according to an embodiment of the disclosure.

The O-DU in FIG. 15 is the same as the O-DUs described in FIGS. 1A to 12 and may be configured to perform the same or similar operations.

According to an embodiment, in an O-DU 1500, functions may be included in one device, or each function may be divided into each device.

The O-DU 1500 according to an embodiment of the disclosure may include a control device (or processor) 1510 that controls operations of the O-DU, a transceiver (or transceiver unit) 1520 including a transmitter and a receiver, and a memory 1530. However, the disclosure is not limited to the above example, and the O-DU 1500 may include more or fewer components than those shown in FIG. 15.

According to an embodiment of the disclosure, the transceiver unit 1520 may transmit and receive signals to and from other network nodes (e.g., southbound node, northbound node, O-RU, controller, middle node, or upper network entity). Signals transmitted and received to and from the middle node may include C-plane, U-plane, S-plane and M-plane signals, uplink data, and downlink data. In addition, the transceiver unit 1520 may receive a signal through a wireless path or a wired path such as a fiber and transmit it to the processor 1510, and transmit a signal determined and output from the processor 1510 through the path.

According to an embodiment of the disclosure, the processor 1510 may control an O-DU device to perform the operation of any one of the embodiments of FIGS. 1A to 12. Meanwhile, the processor 1510, the memory 1530, and the transceiver unit 1520 do not necessarily have to be implemented as separate modules, and may be implemented as one component in the form of a single chip. In addition, the processor 1510, the memory 1530, and the transceiver unit 1520 may be electrically connected to each other. Furthermore, the processor 1510 may be an application processor (AP), a communication processor (CP), a circuit, an application-specific circuit, or at least one processor.

According to an embodiment of the disclosure, the memory 1530 may store data such as basic programs, applications, and configuration information for the operation of the O-DU 1500. In addition, the memory 1530 may store uplink and downlink data received by the O-DU. In particular, the memory 1530 may provide stored data in response to a request from the processor 1510. The memory 1530 may be composed of a storage medium such as ROM, RAM, hard disk, CD-ROM, and DVD, or a combination of storage media. In addition, there may be a plurality of memories 1530. In addition, the processor 1510 may perform the embodiments described above based on a program stored in the memory 1530 for performing the embodiments of the disclosure described above.

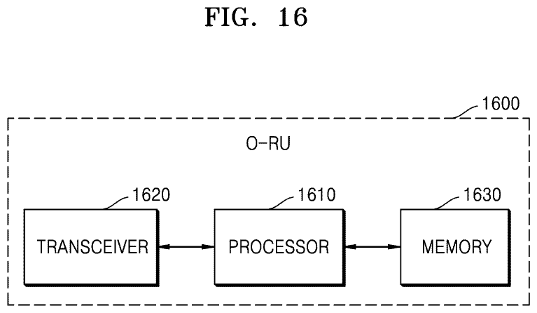

FIG. 16 is a view of a configuration of an O-RU according to an embodiment of the disclosure.

The O-RU in FIG. 16 is the same as the O-RUs described in FIGS. 1A to 12 and may be configured to perform the same or similar operations.

According to an embodiment, in an O-RU 1600, functions may be included in one device, or each function may be divided into each device.

The O-RU 1600 according to an embodiment of the disclosure may include a control device (or processor) 1610 that controls operations of the O-RU, a transceiver (or transceiver unit) 1620 including a transmitter and a receiver, and a memory 1630. However, the disclosure is not limited to the above example, and the O-RU 1600 may include more or fewer components than those shown in FIG. 16.

According to an embodiment of the disclosure, the transceiver unit 1620 may transmit and receive signals to and from other network nodes (e.g., southbound node, northbound node, O-DU, controller, middle node, or upper network entity). Signals transmitted and received to and from the middle node may include C-plane, U-plane, S-plane and M-plane signals, uplink data, and downlink data. In addition, the transceiver unit 1620 may receive a signal through a wireless path or a wired path such as a fiber and transmit it to the processor 1610, and transmit a signal determined and output from the processor 1610 through the path.

According to an embodiment of the disclosure, the processor 1610 may control an O-RU device to perform the operation of any one of the embodiments of FIGS. 1A to 12. Meanwhile, the processor 1610, the memory 1630, and the transceiver unit 1620 do not necessarily have to be implemented as separate modules, and may be implemented as one component in the form of a single chip. In addition, the processor 1610, the memory 1630, and the transceiver unit 1620 may be electrically connected to each other. Furthermore, the processor 1610 may be an application processor (AP), a communication processor (CP), a circuit, an application-specific circuit, or at least one processor.

According to an embodiment of the disclosure, the memory 1630 may store data such as basic programs, applications, and configuration information for the operation of the O-RU 1600. In addition, the memory 1630 may store uplink and downlink data received by the O-RU. In particular, the memory 1630 may provide stored data in response to a request from the processor 1610. The memory 1630 may be composed of a storage medium such as ROM, RAM, hard disk, CD-ROM, and DVD, or a combination of storage media. In addition, there may be a plurality of memories 1630. In addition, the processor 1610 may perform the embodiments described above based on a program stored in the memory 1630 for performing the embodiments of the disclosure described above.

Various operations of the methods described above may be performed by any suitable means capable of performing corresponding functions. The means includes, but is not limited to, various hardware and/or software components and/or modules such as an ASIC or a processor. In general, when there are operations corresponding to the drawings, these operations may have a corresponding counterpart and functional components having the same number as the number of the counterpart.

The various illustrative logic blocks, components, or circuits described in connection with the disclosure may be implemented or performed by a general-purpose processor designed to perform the functions disclosed herein, a digital signal processor (DSP), an ASIC, an FPGA or other programmable logic device (PLD), a discrete gate or transistor logic device, discrete hardware components, or any combination thereof. The general-purpose processor may be a microprocessor, but may alternatively be any commercially available processor, control device, microcontroller, or state machine. The processor may also be implemented in a combination of computing devices, for example, a combination of the DSP and the microprocessor, a plurality of microprocessors, one or more microprocessors in connection with a DSP core, or any other configuration.

The term “determine” includes a wide variety of actions. For example, the term “determine” may include computing, processing, deriving, examining, looking up (e.g., looking up in a table, database, or other data structure), identifying, and the like. The term “determine” may also include receiving (e.g., receiving information), accessing (accessing data in a memory), and the like. The term “determine” may also include resolving, selecting, choosing, establishing, and the like.

Numerous modifications and adaptations will be readily apparent to one of ordinary skill in the art without departing from the spirit and scope of the disclosure.

Accordingly, the embodiments illustrated in the disclosure are not intended to limit the inventive concept of the disclosure but are for illustrative purposes, and the scope of the inventive concept of the disclosure is not limited by these embodiments.

The scope of protection of the inventive concept of the disclosure should be interpreted in accordance with the claims below, and all technical ideas within the equivalent scope should be construed as being included in the scope of inventive concept of the disclosure.

1. A method performed by a controller in a communication system, the method comprising:
receiving sub-carrier spacing (SCS) capability information from each of a plurality of O-RUs;
receiving slot identifier (slotld) configuration capability information from each of the plurality of O-RUs;
generating slotId configuration information based on the received SCS capability information and slotId configuration capability information; and
transmitting the generated slotId configuration information to an O-DU and the plurality of O-RUs.

2. The method of claim 1, wherein the SCS capability information comprises information indicating what SCS each of the plurality of O-RUs supports, and
the slotId configuration capability information comprises information indicating whether each of the plurality of O-RUs may change slotId.

3. The method of claim 1, wherein the generating slotld configuration information based on the received SCS capability information and slotld configuration capability information comprises:
identifying whether slotId configuration capability information of at least one O-RU from among the plurality of O-RUs comprises information indicating that slotId can be changed; and,
if the slotId configuration capability information of the at least one O-RU comprises information indicating that slotId can be changed, generating the slotId configuration information based on SCS capability information of an O-RU, in which the slotId configuration capability information comprises information indicating that slotId cannot be changed.

4. The method of claim 1, wherein the generating slotld configuration information based on the received SCS capability information and slotld configuration capability information comprises:
identifying whether slotId configuration capability information of at least one O-RU from among the plurality of O-RUs comprises information indicating that slotId can be changed; and
generating slotId configuration information of the at least one O-RU based on communication quality of the controller.

5. A controller in a communication system, the controller comprising:
a transceiver;
a memory; and
at least one processor electrically connected to the transceiver and the memory,
wherein the at least one processor is configured to:
receive sub-carrier spacing (SCS) capability information from each of a plurality of O-RUs;
receive slot identifier (slotld) configuration capability information from each of the plurality of O-RUs;
generate slotId configuration information based on the received SCS capability information and slotId configuration capability information; and
transmit the generated slotId configuration information to an O-DU and the plurality of O-RUs.

6. The controller of claim 5, wherein the SCS capability information comprises information indicating what SCS each of the plurality of O-RUs supports, and
the slotId configuration capability information comprises information indicating whether each of the plurality of O-RUs may change slotld.

7. The controller of claim 5, wherein the at least one processor is configured to:
identify whether slotId configuration capability information of at least one O-RU from among the plurality of O-RUs comprises information indicating that slotId can be changed; and,
if the slotId configuration capability information of the at least one O-RU comprises information indicating that slotId can be changed, generate the slotId configuration information based on SCS capability information of an O-RU, in which the slotId configuration capability information comprises information indicating that slotId cannot be changed.

8. The controller of claim 5, wherein the at least one processor is configured to:
identify whether slotId configuration capability information of at least one O-RU from among the plurality of O-RUs comprises information indicating that slotId can be changed; and
generate slotId configuration information of the at least one O-RU based on communication quality of the controller.
